(19) United States
(12) Patent Application Publication
(10) Pub. No.: US 2018/0082334 A1
(43) Pub. Date: Mar. 22, 2018

(54) INFORMATION OUTPUT CONTROL APPARATUS, INFORMATION OUTPUT CONTROL METHOD, AND COMPUTER-READABLE STORAGE MEDIUM

(71) Applicant: CASIO COMPUTER CO., LTD., Tokyo (JP)

(72) Inventors: Hiroaki Shimoda, Hamura-shi (JP); Toshihiko Yoshida, Fussa-shi (JP); Yoichi Murayama, Fussa-shi (JP); Gou Kawakami, Fussa-shi (JP); Kazuma Kawahara, Akishima-shi (JP); Takashi Kawashimo, Hamura-shi (JP)

(21) Appl. No.: 15/703,613

(22) Filed: Sep. 13, 2017

(30) Foreign Application Priority Data
Sep. 16, 2016 (JP) 2016-181286

(51) Int. Cl. G06Q 30/02; H04N 9/31; G06F 3/16

(52) U.S. Cl. CPC G06Q 30/0261; H04N 9/3194; G06F 3/165; G06K 9/00255; G06Q 30/0269; G06Q 30/0244; H04N 9/3188

(57) ABSTRACT

According to one embodiment, with respect to each of content data Cn (or an output form thereof) which is output, audience information for use in output control of the content data Cn, a condition of external information for executing the output control, and a content of the output control which is executed when the condition is satisfied, are set up, and are set in an output control information definition file 20D. From photography data including an audience photographed by an image photography unit, and from external information such as a distance to a subject, which is measured by a range finder, the external information of a kind corresponding to each content Cn that is output is acquired. By judging whether the condition of the external information is satisfied or not, the content of the output control is executed.

### CROSS-REFERENCE TO RELATED APPLICATION

This application is based upon and claims the benefit of priority from prior Japanese Patent Application No. 2016-181286, filed Sep. 16, 2016, the entire contents of which are incorporated herein by reference.

### BACKGROUND OF THE INVENTION

### 1. Field of the Invention

The present invention relates to an information output control apparatus, an information output control method, and a computer readable storage medium thereof.

### 2. Description of the Related Art

There is known an information output apparatus which outputs content information such as advertisements, in various output forms such as a moving picture, a still image, and sound. In this information output apparatus, it is desirable to output content information such that an audience can easily view the content information.

In a conventional image display apparatus as disclosed in Jpn. Pat. Appln. KOKAI Publication No. 2014-044369, a technique for providing a screen, which can easily be viewed by a large audience, has been thought. In this technique, image data is enlarged or reduced in accordance with the kind of image data which is displayed on a display screen, and the distance between the display screen and the audience.

### BRIEF SUMMARY OF THE INVENTION

In general, according to one embodiment, an information output control apparatus includes a memory configured to store a program which is executed by a processor; and the processor configured to execute the program. The processor is configured to: acquire content information, and a kind of external information for use in output control of the content information; acquire external information, based on the acquired kind of external information; and execute the output control of the content information, based on the acquired external information.

According to another embodiment, an information output control method includes acquiring content information, and a kind of external information for use in output control of the content information; acquiring external information, based on the content information which an output unit outputs; and executing output control of the content information, based on the acquired external information.

According to still another embodiment, a computer-readable non-transitory storage medium which stores a program for causing a computer to execute a process of acquiring content information, and a kind of external information for use in output control of the content information; a process of acquiring external information, based on the acquired kind of external information; and a process of executing the output control of the content information, based on the acquired external information.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is a front view of an external appearance configuration of a signage device 10 according to an embodiment of an information output control apparatus of the present invention.

FIG. 1B is a plan view of the external appearance configuration of the signage device 10 according to the embodiment of the information output control apparatus of the present invention.

FIG. 2 is a block diagram illustrating a functional configuration of electronic circuitry of the signage device 10.

FIG. 3 is a view illustrating a content data area 20C which is secured in a content memory 20 of the signage device 10.

FIG. 4 is a view illustrating the content of data stored in an output control information definition file 20D which is secured in the content memory 20 of the signage device 10.

FIG. 5 is a view illustrating an example of an audience list 27L which is created based on a person recognition function, a gender determination function and an audience judgment function of the signage device 10, and is temporarily stored in a main memory 27.

FIG. 6 is a flowchart illustrating a content output process of the signage device 10.

### DETAILED DESCRIPTION OF THE PREFERRED EMBODIMENTS

An embodiment of the present invention will be described hereinafter with reference to the accompanying drawings.

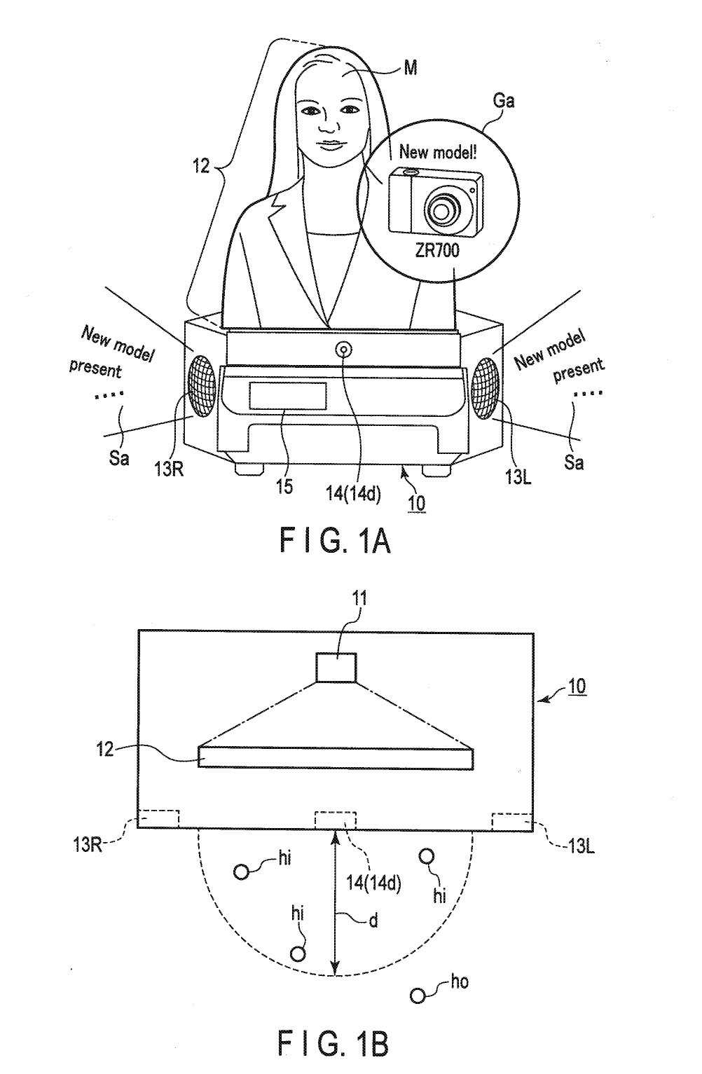

FIG. 1A is a front view of an external appearance configuration of a signage device 10 according to an embodiment of an information output control apparatus of the present invention.

FIG. 1B is a plan view of the external appearance configuration of the signage device 10 according to the embodiment of the information output control apparatus of the present invention.

This signage device 10 is an electronic mannequin using a projector technique, and is disposed, for example, on a store front of a commercial facility.

This signage device 10 includes a screen panel 12. An image is projected from the rear side and displayed on the screen panel 12 by a projection portion 11 of a rear projection type, which is built in the device main body. For example, an advertisement image Ga of a moving picture or a still image, which includes an advertisement model M of a product explainer or the like, is projected and displayed on the screen panel 12.

In addition, the signage device 10 includes speakers 13L and 13R. An advertisement sound Sa, which corresponds to the advertisement image Ga projected on the screen panel 12, is output from the speakers 13L and 13R.

The advertisement image Ga and advertisement sound Sa are edited and generated as single content data in association with each of different advertisements. Each advertisement (content data) is selected by, for example, a person who installed the signage device 10, and is output.

Incidentally, the content data is not limited to a combination between an image (a moving picture, or a still image, or both) and sound. The content data may be one of them. The moving picture, still image and sound are output forms of content data.

An image photography unit 14 (external information acquisition unit), which photographs a person who approaches the front surface of the device main body, is provided at a center of the front surface of the device main body. A range finder 14d, which measures a distance to a subject, is provided in the image photography unit 14. In addition, a display 15 is also provided on the front panel of the device main body.

In addition, the signage device 10 includes a person recognition function of recognizing, based on photography data captured by the image photography unit 14, a person included in the photography data; a face recognition function of recognizing the face of the person-recognized person who was recognized by the person recognition; a gender determination function of determining the gender of the face-recognized person; and an audience judgment function of judging, as an audience hi, a person among the person-recognized persons (hi, ho), who is located within an output target range (within a distance d on the front side of the device main body) of the content data, the output target range being set in accordance with the content data (or the output form of the content data).

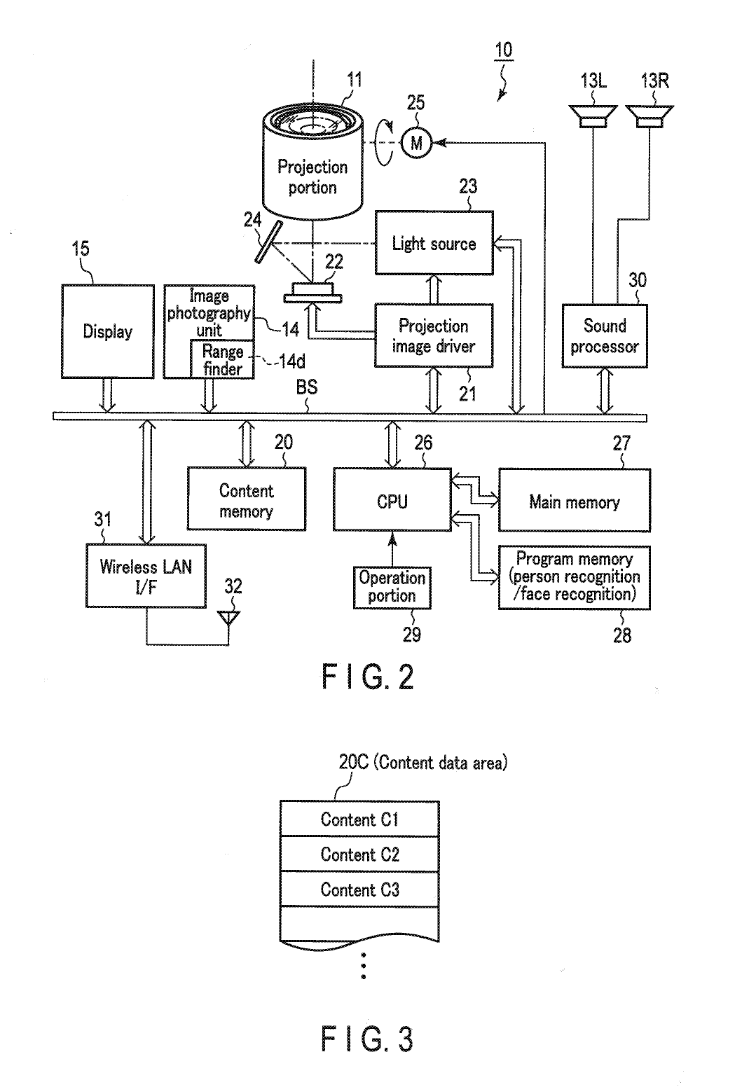

FIG. 2 is a block diagram illustrating a functional configuration of electronic circuitry of the signage device 10.

FIG. 3 is a view illustrating a content data area 20C which is secured in a content memory 20 (storage unit) of the signage device 10.

A plurality of kinds of content data C1, C2, C3, . . . , such as advertisements, are generated in advance and stored in the content data area 20C. The plurality of kinds of content data C1, C2, C3, . . . , which are stored in the content data area 20C, are selectively read out by a CPU 26 (to be described later), and are sent to a projection image driver 21 via a system bus BS.

This projection image driver 21 drives a micromirror element 22 which is a display element, by higher time-division drive obtained by multiplication of a frame rate following a predetermined format, for example, 120 [frames/second], a division number of a color component, and the number of display gradations, in accordance with the data of the image Ga which was sent via the system bus BS.

This micromirror element 22 executes a display operation by operating, with an individual high-speed ON/OFF operation, each inclination angle of a plurality of micromirrors corresponding to, for example, WXGA (Wide eXtended Graphic Array) (lateral 1280 pixels×longitudinal 768 pixels) arranged in an array shape, thereby forming an optical image by reflection light.

On the other hand, a light source 23 cyclically emits lights of R, G, B primary colors in a time-division manner. This light source 23 includes LEDs which are semiconductor light-emitting elements, and repeatedly emits the lights of R, G, B primary colors in a time-division manner. The LEDs, which the light source 23 includes, may include, in a broad sense, LDs (semiconductor lasers) and organic EL elements.

In addition, use may be made of primary-color lights which are different in wavelength from original lights, the primary-color lights being excited by irradiating phosphors with the lights emitted from the LEDs. The primary-color lights from the light source 23 are reflected by a mirror 24 and radiated on the micromirror element 22.

An optical image is formed by the reflected light from the micromirror element 22, and the formed optical image is projected from the rear side of the screen panel 12 via the projection portion 11.

The projection portion 11 includes, in a lens optical system thereof, a focus lens which can vary an in-focus position, and a zoom lens which can vary a projection view angle. Each of the focus lens and zoom lens moves along the lens optical axis by the rotation driving of a lens motor (M) 25. Thereby, the in-focus position and projection view angle of the optical image, which the projection portion 11 emits, are varied.

The CPU 26 controls all operations of the above-described circuitry components. The CPU 26 is connected directly to a main memory 27 and a program memory 28.

The main memory 27 is composed of, for example, an SRAM, and functions as a work memory of the CPU 26.

The program memory 28 is composed of an electrically rewritable nonvolatile memory, for example, a flash ROM, and stores operation programs which the CPU 26 executes, various standardized data, and the like. The operation programs include a person recognition program for recognizing a person image from the data of images captured by the image photography unit 14, and a face recognition program for recognizing a face image from the data of the recognized person image.

The CPU 26 comprehensively controls the signage device 10 by reading out the operation programs and standardized data stored in the program memory 28, developing them in the main memory 27, and executing the programs.

The CPU 26 executes various projection operations in accordance with operation signals from the operation portion 29. This operation portion 29 sends to the CPU 26 key operation signals of some operation keys including a power key, these operation keys being included in the main body of the signage device 10.

The CPU 26 is further connected via the system bus BS to the image photography unit 14, range finder 14d, display 15, a sound processor 30, and a wireless LAN interface (I/F) 31.

The sound processor 30 includes a sound source circuit such as a PCM sound source. The sound processor 30 converts sound data in content data Cn, which is read out from the content data area 20C of the content memory 20 at a time of a projection operation, to an analog signal, and drives the speakers 13L and 13R to produce sound, or to produce a beep sound or the like when necessary.

The wireless LAN interface 31 is connected to a nearby wireless LAN router (not shown) via a wireless LAN antenna 32, and executes data transmission and reception. When necessary, the wireless LAN interface 31 acquires content data or the like, which is to be stored in the content memory 20.

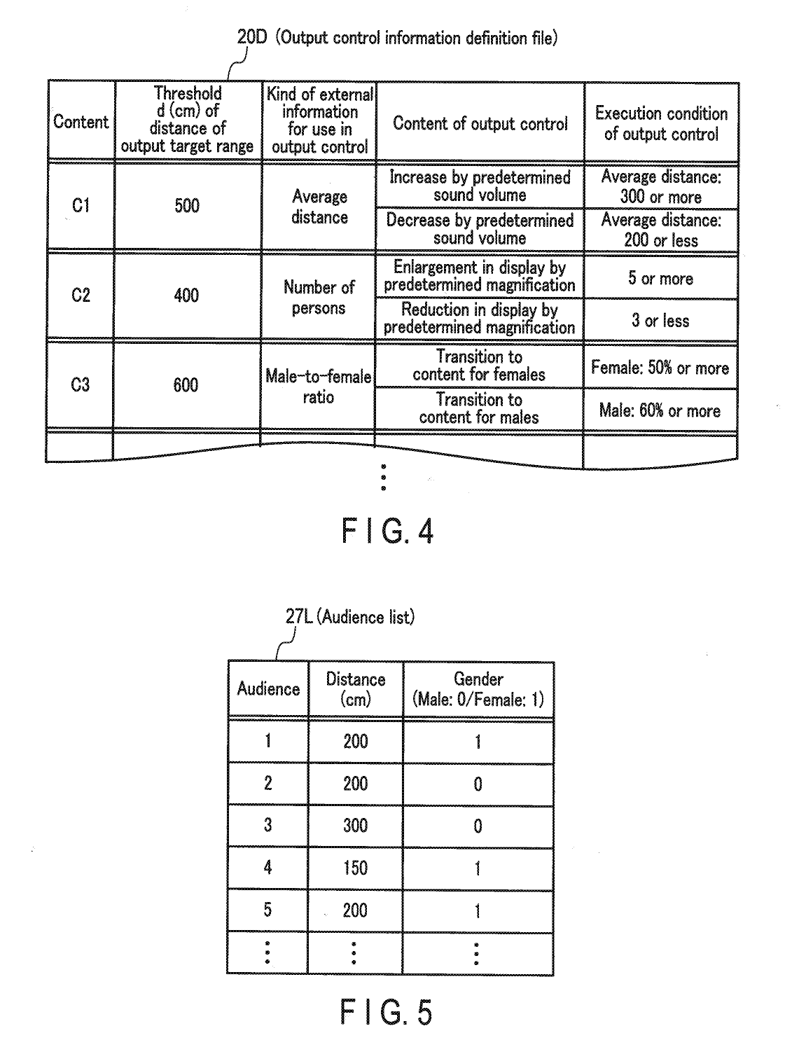

FIG. 4 is a view illustrating the content of data stored in an output control information definition file 20D which is secured in the content memory 20 (storage unit) of the signage device 10.

In this output control information definition file 20D, information (output control information) for controlling the output of the content data is defined with respect to each of the content data (or the output form thereof) C1, C2, . . . . Examples of this defined output control information include a threshold d (cm) of the distance for setting an output target range; the kind of external information for use in output control (the information which is necessary for grasping the state of the audience); the content of the output control (the output mode of content data); and execution conditions of the output control.

As the kind of external information for use in output control, for example, the following are defined: the distance to each audience person hi within the output target range d, the number of audience persons hi, the male-to-female ratio of audience persons hi, and the lines of sight of audience persons hi.

In addition, as the content of the output control, for example, the following are defined: enlargement/reduction of image display, an increase/decrease of image display brightness, emphasis of image display, an increase/decrease of a sound volume, a change of sound directivity, a transition to different content, and a stop/resume of output. In accordance with these contents of the output control, the CPU 26 (output controller) controls the output mode of the content data.

Furthermore, as the execution conditions of the output control, numerical values (thresholds), which indicate concrete states of the external information, are defined. When the execution condition of output control is satisfied, the CPU 26 controls the output mode of content data in accordance with the content of output control.

In the meantime, in the present embodiment, the following is assumed. The content data C1 is a content which is to be appealed to the audience hi, mainly based on the advertisement sound Sa. The content data C2 is a content which is to be appealed to the audience hi, mainly based on the advertisement image Ga. The content data C3 is a content which, in itself, differs in the degree of appeal in accordance with the gender of the audience hi.

In addition, the output control information of the content data C1 is set and defined as follows. The threshold d of the distance for setting the output target range is [500]. The kind of external information for use in output control is [average distance to respective audience persons hi]. The content of output control is [increase/decrease of sound volume]. The execution condition of output control is [average distance: 300 or more; 200 or less].

The output control information of the content data C2 is set and defined as follows. The threshold d of the distance for setting the output target range is [400]. The kind of external information for use in output control is [the number of audience persons hi]. The content of output control is [enlargement/reduction of image display]. The execution condition of output control is [number of audience: 5 or more; 3 or less].

The output control information of the content data C3 is set and defined as follows. The threshold d of the distance for setting the output target range is [600]. The kind of external information for use in output control is [male-to-female ratio of audience persons hi]. The content of output control is [transition to content for females/transition to content for males]. The execution condition of output control is [audience male-to-female ratio: female=50% or more; male=60% or more].

FIG. 5 is a view illustrating an example of an audience list 27L which is created based on the person recognition function, gender determination function and audience judgment function of the signage device 10, and is temporarily stored in the main memory 27.

This audience list 27L is created as data in which the distance and gender (male: 0/female: 1) of each of audience persons hi located within the output target range d are associated. In addition, this audience list 27L is repeatedly created and updated while the content data is being output.

In the signage device 10 with the above-described configuration, the CPU 26 controls the respective components of the above-described electronic circuitry in accordance with the instructions described in the operation programs, and the software and hardware cooperatively operate, thereby realizing an information output control function which will be described in the following description of the operation.

Next, the operation of the signage device 10 with the above-described configuration will be described.

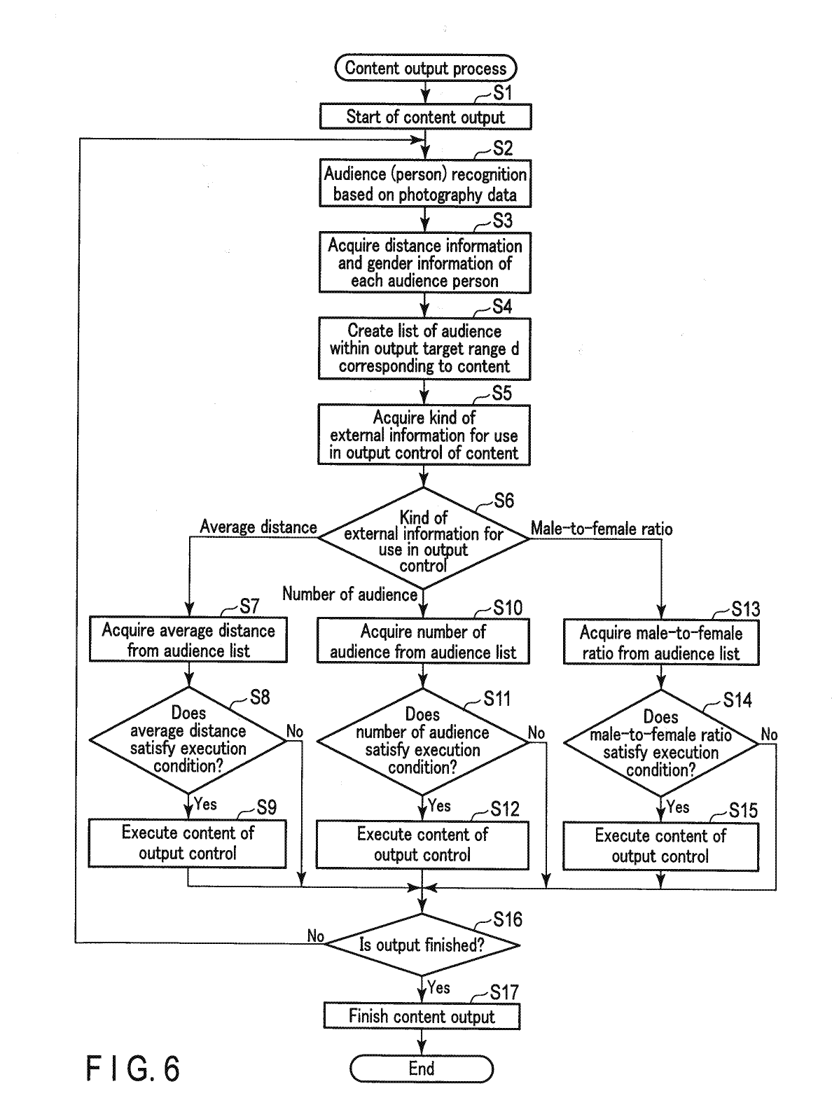

FIG. 6 is a flowchart illustrating a content output process of the signage device 10.

If any one of content data Cn stored in the content data area 20C (see FIG. 3) is read out and the output of the read-out content data Cn is started in accordance with the execution of the operation program by the CPU 26 according to the operation of the operation portion 29 of the signage device 10, the advertisement image Ga of the content data Cn is projected and displayed on the screen panel 12, and the advertisement sound Sa of the content data Cn is output from the speakers 13R and 13L (step S1).

Here, it is assumed that the output of the content data C1 is started.

Subsequently, with respect to photography data on the front side of the device main body, which is being photographed by the image photography unit 14, an audience (persons) included in the photography data is recognized (step S2), and the distances to person-recognized audience persons (including hi and ho), who were recognized by the person recognition, are measured and acquired by the range finder 14d. In addition, the faces of the person-recognized audience persons are recognized, and the genders of the face-recognized audience persons are determined and acquired (step S3).

Then, the audience list 27L (see FIG. 5) is created and temporarily stored in the main memory 27 (step S4). The audience list 27L includes the distance to each audience person hi and the gender of each audience person hi. The audience person hi is located within the output target range of a radius of 500 cm on the front side of the device main body, this output target range corresponding to the threshold d (=500 cm) of the distance of the output target range defined in the output control information definition file 20D (see FIG. 4) in association with the content data C1 that is currently output.

Here, the kind of external information for use in output control is acquired (step S5). The kind of external information corresponds to the content data C1 which is currently output, and is defined in the output control information definition file 20D (see FIG. 4). Here, since the kind of external information for use in output control, which corresponds to the content data C1, is [average distance], the process advances to step S7 (step S6). The CPU 26 refers to the audience list 27L which was created in step S4, acquires distances to the respective audience persons hi, and calculates the average distance of these distances (step S7). Next, based on the execution condition of output control, [average distance: 300 or more; 200 or less], which corresponds to the content data C1, the CPU 26 judges whether the average distance to each audience person hi included in the audience list 27L is 300 cm or more, or 200 cm or less, that is, whether the execution condition of output control is satisfied or not (step S8).

For example, when the average distance to each audience person hi, which was acquired in step S7, is 300 cm or more, and it is judged that the execution condition of output control is satisfied (step S8 (Yes)), the CPU 26 executes control to increase, via the sound processor 30, the sound volume of the advertisement sound Sa, which is being output from the speakers 13R and 13L, by a predetermined amount, in accordance with the content of output control, [increase of sound volume], which is defined in the output control information definition file 20D (see FIG. 4) in association with the content data C1 which is currently output (step S9).

Thereby, even if each audience person hi, who is located within the output target range, is located on a relatively outer side within this range, the advertisement sound Sa can be output with a proper sound volume which is sufficiently audible.

In addition, for example, when the average distance to each audience person hi, which was acquired in step S7, is 200 cm or less, and it is judged that the execution condition of output control is satisfied (step S8 (Yes)), the CPU 26 executes control to decrease, via the sound processor 30, the sound volume of the advertisement sound Sa, which is being output from the speakers 13R and 13L, by a predetermined amount, in accordance with the content of output control, [decrease of sound volume], which is defined in the output control information definition file 20D (see FIG. 4) in association with the content data C1 which is currently output (step S9).

Thereby, even if each audience person hi, who is located within the output target range, is located on a relatively inner side within this range, the advertisement sound Sa can be output with a proper sound volume which is audible with no annoyance.

On the other hand, in step S8, if it is judged that the execution condition of output control fails to be satisfied (step S8 (No)), the sound volume of the advertisement sound Sa, which is being output from the speakers 13R and 13L, is kept unchanged.

Then, in a state in which the output of the content data C1 is not judged to be finished in accordance with an operation of the operation portion 29 or in accordance with auto-control (step S16 (No)), the process of the above step S2 onwards is repeatedly executed, and the audience list 27L is updated each time. In addition, the volume control of the advertisement sound Sa is executed, depending on whether the external information [average distance], which was acquired in accordance with the currently output content data C1 (or the output form thereof), satisfies the execution condition of output control or not (steps S2 to S16).

Thereafter, if the output of the content data C1 is judged to be finished (step S16 (Yes)), the output of the content data C1 is finished (step S17).

(Output of Content Data C2)

Next, a description will be given of a main operation in a state in which the content data C2 is being output in accordance with the same content output process as described above.

If the output of the content data C2 is started, the audience list 27L (see FIG. 5) is created and temporarily stored in the main memory 27 (steps S1 to S4). The audience list 27L includes the distance to each audience person hi and the gender of each audience person hi. The audience person hi is located within the output target range of a radius of 400 cm on the front side of the device main body, this output target range corresponding to the threshold d (=400 cm) of the distance of the output target range defined in the output control information definition file 20D (see FIG. 4) in association with the content data C2.

Here, the kind of external information for use in output control is acquired (step S5). The kind of external information corresponds to the content data C2 which is currently output, and is defined in the output control information definition file 20D (see FIG. 4). Here, since the kind of external information for use in output control, which corresponds to the content data C2, is [number of audience], the process advances to step S10 (step S6). The CPU 26 refers to the audience list 27L which was created in step S4, and acquires the number of audience persons hi (step S10). Next, based on the execution condition of output control, [the number of audience: 5 or more; 3 or less], which corresponds to the content data C2, the CPU 26 judges whether the number of audience persons hi included in the audience list 27L is 5 or more, or 3 or less, that is, whether the execution condition of output control is satisfied or not (step S11).

For example, when the number of audience persons hi, which was acquired in step S10, is 5 or more, and it is judged that the execution condition of output control is satisfied (step S11 (Yes)), the CPU 26 executes control to enlarge, via the projection portion 11, the display size of the advertisement image Ga, which is being projected on the screen panel 12, by a predetermined magnification, in accordance with the content of output control, [enlargement of image display], which is defined in the output control information definition file 20D (see FIG. 4) in association with the content data C2 which is currently output (step S12).

Thereby, even if the number of audience persons hi, who are located within the output target range, has increased and the screen panel 12 has become relatively difficult to view, the advertisement image Ga can be displayed such that a main part of the advertisement image Ga is displayed in close-up, with such a proper display size as to enable sufficient viewing by all audience persons.

In addition, for example, when the number of audience persons hi, which was acquired in step S10, is 3 or less, and it is judged that the execution condition of output control is satisfied (step S11 (Yes)), the CPU 26 executes control to reduce, via the projection portion 11, the display size of the advertisement image Ga, which is being projected on the screen panel 12, by a predetermined magnification, in accordance with the content of output control, [reduction of image display], which is defined in the output control information definition file 20D (see FIG. 4) in association with the content data C2 which is currently output (step S12).

Thereby, if the number of audience persons hi, who are located within the output target range, has decreased within this range and the screen panel 12 has become relatively easy to view, the advertisement image Ga can be displayed with such a proper display size as to enable viewing of the entirety of the advertisement image Ga from end to end.

On the other hand, in step S11, if it is judged that the execution condition of output control fails to be satisfied (step S11 (No)), the display size of the advertisement image Ga, which is being projected on the screen panel 12, is kept unchanged.

Then, in a state in which the output of the content data C2 is not judged to be finished in accordance with an operation of the operation portion 29 or in accordance with auto-control (step S16 (No)), the process of the above step S2 onwards is repeatedly executed, and the audience list 27L is updated each time. In addition, the control of the display size of the advertisement image Ga is executed, depending on whether the external information [number of audience], which was acquired in accordance with the currently output content data C2 (or the output form thereof), satisfies the execution condition of output control or not (steps S2 to S16).

(Output of Content Data C3)

Next, a description will be given of a main operation in a state in which the content data C3 is being output in accordance with the same content output process as described above.

If the output of the content data C3 is started, the audience list 27L (see FIG. 5) is created and temporarily stored in the main memory 27 (steps S1 to S4). The audience list 27L includes the distance to each audience person hi and the gender of each audience person hi. The audience person hi is located within the output target range of a radius of 600 cm on the front side of the device main body, this output target range corresponding to the threshold d (=600 cm) of the distance of the output target range defined in the output control information definition file 20D (see FIG. 4) in association with the content data C3.

Here, the kind of external information for use in output control is acquired (step S5). The kind of external information corresponds to the content data C3 which is currently output, and is defined in the output control information definition file 20D (see FIG. 4). Here, since the kind of external information for use in output control, which corresponds to the content data C3, is [male-to-female ratio of audience], the process advances to step S13 (step S6). The CPU 26 refers to the audience list 27L which was created in step S4, and acquires the male-to-female ratio of audience persons (step S13). Next, based on the execution condition of output control, [female=50% or more; male=60% or more], which corresponds to the content data C3, the CPU 26 judges whether females are 50% or more, or males are 60% or more, based on the genders of audience persons hi included in the audience list 27L, that is, whether the execution condition of output control is satisfied or not (step S14).

For example, when the male-to-female ratio of audience persons hi, which was acquired in step S13, is “female=50% or more”, and it is judged that the execution condition of output control is satisfied (step S14 (Yes)), the CPU 26 executes control to make a transition from the content data C3, which is being output, to a content part for females, which is included, for example, in the same content data C3 by editing, in accordance with the content of output control, [transition to content for females], which is defined in the output control information definition file 20D (see FIG. 4) in association with the content data C3 which is currently output (step S15).

Thereby, when the male-to-female ratio of audience persons hi, who are located within the output target range, has become “female=50% or more”, the currently output content can be changed to content for females, which is suited to the audience, and the content for females can be output.

In addition, for example, when the male-to-female ratio of audience persons hi, which was acquired in step S13, is “male=60% or more”, and it is judged that the execution condition of output control is satisfied (step S14 (Yes)), the CPU 26 executes control to make a transition from the content data C3, which is being output, to a content part for males, which is included, for example, in the same content data C3 by editing, in accordance with the content of output control, [transition to content for males], which is defined in the output control information definition file 20D (see FIG. 4) in association with the content data C3 which is currently output (step S15).

Thereby, when the male-to-female ratio of audience persons hi, who are located within the output target range, has become “male=60% or more”, the currently output content can be changed to content for males, which is suited to the audience, and the content for males can be output.

On the other hand, in step S14, if it is judged that the execution condition of output control fails to be satisfied (step S14 (No)), the currently output content is kept unchanged.

Then, in a state in which the output of the content data C3 is not judged to be finished in accordance with an operation of the operation portion 29 or in accordance with auto-control (step S16 (No)), the process of the above step S2 onwards is repeatedly executed, and the audience list 27L is updated each time. In addition, the control to change the currently output content is executed, depending on whether the external information [audience male-to-female ratio], which was acquired in accordance with the currently output content data C3, satisfies the execution condition of output control or not (steps S2 to S16).

According to the signage device 10 with the above-described configuration, in accordance with the content data Cn which is output (or the output form of the main substance of this content), the audience information for use in the output control of the content data Cn (the kind of external information [C1: average distance to audience/C2: number of audience/C3: audience male-to-female ratio/ . . . ), the condition of the external information for executing the output control [C1: threshold of average distance/C2: threshold of number of audience persons/C3: threshold of male-to-female ratio/ . . . ], and the content of output control executed when the condition is satisfied [C1: increase/decrease of sound volume/C2: enlargement/reduction of image/C3: transition of content/ . . . ] are preset and are set in the output control information definition file 20D. In addition, from the photography data including the audience photographed by the image photography unit 14, and from the acquired external information such as the distance to the subject, which is measured by the range finder 14d, the external information based on the kind of external information, which corresponds to each of the content data Cn that are output, is acquired. By judging whether the condition of the external information is satisfied or not, the content of the output control is executed.

Thereby, when the output form of the content data Cn is, for example, mainly sound, the average distance to audience is acquired, and the volume of the sound can properly be controlled by being increased/decreased. In addition, when the output form of the content data Cn is mainly an image, the number of audience persons is acquired, and the display size of the image can properly be controlled by being enlarged/reduced. Besides, when the content data Cn is, for example, a content which differs in the degree of appeal in accordance with the gender of the audience, the audience male-to-female ratio is acquired, and the output content can be changed and controlled.

Therefore, the external information that is suited to each content information can be acquired, and the content information can be output more appropriately.

In the meantime, in the configuration of the above-described embodiment, the execution condition of output control, which is defined with respect to each content data Cn, is set to be the threshold of external information, which is defined with respect to each content data Cn. Based on whether this threshold is satisfied or not, the content of output control is executed. However, in an alternative configuration, based on whether the execution condition of the output control (the threshold of the external information) is satisfied for a predetermined time or more, the content of output control may be executed.

In addition, in the above embodiment, the description was given on the assumption that various content data Cn are output by the signage device 10. However, needless to say, the signage device 10 may be replaced with any other device which can output a moving picture, a still image, and sound.

Besides, the above embodiment has such a configuration that the image photography unit 14 and range finger 14d for acquiring the audience information are provided in the device main body of the signage device 10. However, in an alternative configuration, the image photography unit 14 and range finger 14d may be provided separately from the device main body.

Additionally, in the above embodiment, the description was given of the mode in which the audience list 27L is created in advance, and thereafter the kind of external information is determined based on the content data Cn which is output, and the corresponding external information is acquired from the audience list 27L. However, the restriction to this content of the embodiment is unnecessary. For example, after the step S1 in FIG. 6, the kind of external information to be acquired may be determined based on the content data which is output, and the external information based on the kind of external information may be acquired by the external information acquisition unit, and then the audience list 27L may be created. In this case, since the kind of external information for use in output control can be judged in advance with respect to each content data Cn, such a mode may be adopted that only necessary external information is acquired in a subsequent step of acquiring external information.

In the meantime, the methods of the respective processes by the signage device 10 and the data such as files, which have been described in the above embodiment, that is, the methods of the content output process illustrated in the flowchart of FIG. 6, etc. and the data of the output control information definition file 20D illustrated in FIG. 4, etc. can all be stored as computer-executable programs in a medium of an external storage device, such as a memory card (ROM card, RAM card, etc.), a magnetic disk (floppy (trademark) disk, hard disk, etc.), an optical disc (CD-ROM, DVD, etc.), or a semiconductor memory, and can be distributed. In addition, the computer (CPU) of the electronic device including the display (11, 12) and sound output device (13) reads the program, which is stored in the medium of the external storage device, into the storage device, and the operation is controlled by this read-in program. Thereby, it is possible to realize the content output function, which has been described in each of the embodiments, and to execute the same processes as by the above-described methods.

In addition, the data of the program for realizing each of the above-described methods can be transmitted on a communication network in the form of a program code, and the data of the program can be taken in the electronic device including the display (11, 12) and sound output device (13) from a computer apparatus (program server) connected to this communication network, and stored in the storage device, thereby realizing the above-described content output function.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information output control apparatus comprising a hardware processor:
wherein the hardware processor is configured to:
acquire content information, and a kind of external information for use in output control of the content information;
acquire external information, based on the acquired kind of external information; and
perform an output unit to output the content information, based on the acquired external information.

2. The information output control apparatus according to claim 1, further comprising a memory unit configured to:
store the content information and content control information which indicates an output mode at a time of outputting the content information, by associating the content information and the content control information.

3. The information output control apparatus according to claim 2, wherein the processor is configured to control, by the output control, the output mode of the content information which is output, in accordance with the content control information, based on the acquired external information.

4. The information output control apparatus according to claim 3, wherein the memory unit is configured to store the content control information and an execution condition for executing the content control information, by associating the content control information and the execution condition, and
the processor is configured to perform the output unit to output the content information in the output mode in accordance with the content control information, when the acquired external information satisfies the execution condition.

5. The information output control apparatus according to claim 4, wherein the kind of external information includes a distance between the information output control device and an audience who views the content information,
the memory unit is configured to store an execution condition relating to the distance as one of the execution conditions, and
the processor is configured to:
acquire the distance as the external information;
control a sound volume of the content information as the output mode of the content information, based on the distance and the execution condition relating to the distance.

6. The information output control apparatus according to claim 5, wherein the execution condition relating to the distance is a condition relating to whether the distance is a reference value or more, and
the processor is configured to perform the output unit to increase the sound volume of the content information as the output mode of the content information, when the distance is the reference value or more.

7. The information output control apparatus according to claim 4, wherein the kind of external information includes a number of audience persons who view the content information,
the memory unit is configured to store an execution condition relating to the number of audience person as one of the execution conditions, and
the processor is configured to:
acquire the number of audience person as the external information:
perform the output unit to display the content information in a display size based on the number of audience person and the execution condition relating to the number of audience person.

8. The information output control apparatus according to claim 7, wherein the execution condition relating to the number of audience persons is a condition relating to whether the number of audience persons is a reference value or more, and
the processor is configured to perform the output unit to increase the display size of the content information, when the number of audience person is the reference value or more.

9. The information output control apparatus according to claim 4, wherein the kind of external information includes a male-to-female ratio of audience people who view the content information,
the memory unit is configured to store an execution condition relating to the male-to-female ratio of audience people as one of the execution conditions, and
the processor is configured to:
acquire the male-to-female ratio of audience people as the external information:
perform the output unit to output a content information based on the male-to-female ratio of audience people and the execution condition relating to the male-to-female ratio of audience people.

10. The information output control apparatus according to claim 9, wherein the processor is configured to perform the output unit to change the content information to content for males or to content for females based on the male-to-female ratio of audience people and the execution condition relating to the male-to-female ratio of audience people.

11. The information output control apparatus according to claim 2, wherein the memory unit is configured to store an output form of the content information which is output, and the content information, by associating the output form and the content information.

12. The information output control apparatus according to claim 11, wherein the output form includes one of an image output and a sound output.

13. An information output control method comprising:
acquiring content information, and a kind of external information for use in output control of the content information;
acquiring external information, based on the content information which an output unit outputs; and
performing an output unit to output the content information, based on the acquired external information.

14. A computer-readable non-transitory storage medium which stores a program for causing a computer to execute:
a process of acquiring content information, and a kind of external information for use in output control of the content information;
a process of acquiring external information, based on the acquired kind of external information; and
a process of performing an output unit to output the content information, based on the acquired external information.

15. The information output control apparatus according to claim 4, wherein the memory unit is configured to store an output form of the content information which is output, and the content information, by associating the output form and the content information.

16. The information output control apparatus according to claim 6, wherein the memory unit is configured to store an output form of the content information which is output, and the content information, by associating the output form and the content information.

17. The information output control apparatus according to claim 8, wherein the memory unit is configured to store an output form of the content information which is output, and the content information, by associating the output form and the content information.

18. The information output control apparatus according to claim 10, wherein the memory unit is configured to store an output form of the content information which is output, and the content information, by associating the output form and the content information.
